(19) United States
(12) Patent Application Publication
(10) Pub. No.: US 2023/0130648 A1
(43) Pub. Date: Apr. 27, 2023

(54) SYSTEM FOR MULTIFACTOR AUTHENTICATION UTILIZING AUGMENTED REALITY

(71) Applicant: BANK OF AMERICA CORPORATION, Charlotte, NC (US)

(72) Inventors: Matthew K. Bryant, Gastonia, NC (US); Jesse Wiggins, Johnston, RI (US)

(73) Assignee: BANK OF AMERICA CORPORATION, Charlotte, NC (US)

(21) Appl. No.: 17/507,159

(22) Filed: Oct. 21, 2021

(51) Int. Cl. G06F 21/36; G06F 21/45

(52) U.S. Cl. CPC G06F 21/36; G06F 21/45; G06F 8/61

(57) ABSTRACT

Systems, computer program products, and methods are described herein for multifactor authentication utilizing augmented reality. The present invention may be configured to provide an augmented reality application for installation on a user device; receive authentication credentials from a user; receive, from the augmented reality application, a real-time visual feed of an environment of the user, wherein the environment comprises one or more unique objects; develop a three-dimensional rendering of the one or more unique objects; and store the three-dimensional rendering of the one or more unique objects in a user data configuration. The present invention may be configured to compare the one or more unique objects to the three-dimensional rendering to determine authenticity of the user.

### FIELD OF THE INVENTION

The present invention embraces a system for implementing multifactor authentication based on augmented reality.

### BACKGROUND

Multifactor authentication is used to provide security for user accounts. Multifactor authentication typically includes at least two methods of authentication. Usually, one method is a password. Other methods include single sign-on (SSO), SMS-based methods, one-time password tokens, biometric methods, and others. It may be difficult, or time-consuming, for a user to use many methods of multifactor authentication. For example, if a user were physically disabled, it may be difficult to operate multiple devices and/or applications for a one-time password token. The multifactor authentication process can be enhanced by implementing augmented-reality (AR) technology.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. This summary presents some concepts of one or more embodiments of the present invention in a simplified form as a prelude to the more detailed description that is presented later.

In one aspect, a system for multifactor authentication utilizing augmented reality is presented. The system may include at least one non-transitory storage device and at least one processing device coupled to the at least one non-transitory storage device, where the at least one processing device may be configured to: provide an augmented reality application for installation on a user device. The at least one processing device may be further configured to receive authentication credentials from a user. The at least one processing device may be further configured to receive, from the augmented reality application, a real-time visual feed of an environment of the user, where the environment contains one or more unique objects. The at least one processing device may be further configured to develop a three-dimensional rendering of the one or more unique objects and store the three-dimensional rendering of the one or more unique objects in a user data configuration.

In some embodiments, the at least one processing device is further configured to recognize the one or more unique objects from the real-time visual feed of the environment of the user and compare the one or more unique objects within the real-time visual feed of the environment of the user to the three-dimensional rendering of the one or more unique objects and determine authenticity of the user.

In some embodiments, the at least one processing device is further configured to prompt the user for authentication credentials; upon receiving correct authentication credentials, prompt the user for visual access to the one or more unique objects within the real-time visual feed of the environment of the user; and compare the one or more unique objects from the real-time visual feed of the environment of the user to the three-dimensional rendering of the one or more unique objects.

In some embodiments, the one or more unique objects is a unique physical artifact. In some embodiments, the one or more unique objects is a unique gesture of the user. In some embodiments, the one or more unique objects is a unique movement of a unique physical artifact by the user.

In another aspect, a computer program product for multifactor authentication utilizing augmented reality is presented. The computer program product may include a non-transitory computer-readable medium including code causing a first apparatus to: provide an augmented reality application for installation on a user device. The non-transitory computer-readable medium including code causing a first apparatus to receive authentication credentials from a user. The non-transitory computer-readable medium including code causing a first apparatus to receive, from the augmented reality application, a real-time visual feed of an environment of the user, where the environment contains one or more unique objects. The non-transitory computer-readable medium including code causing a first apparatus to develop a three-dimensional rendering of the one or more unique objects and store the three-dimensional rendering of the one or more unique objects in a user data configuration.

In some embodiments, the non-transitory computer-readable medium may include code causing a first apparatus to recognize the one or more unique objects from the real-time visual feed of the environment of the user and compare the one or more unique objects within the real-time visual feed of the environment of the user to the three-dimensional rendering of the one or more unique objects and determine authenticity of the user.

In some embodiments, the non-transitory computer-readable medium may include code causing a first apparatus to prompt the user for authentication credentials; upon receiving correct authentication credentials, prompt the user for visual access to the one or more unique objects within the real-time visual feed of the environment of the user; and compare the one or more unique objects from the real-time visual feed of the environment of the user to the three-dimensional rendering of the one or more unique objects.

In some embodiments, the one or more unique objects is a unique physical artifact. In some embodiments, the one or more unique objects is a unique gesture of the user. In some embodiments, the one or more unique objects is a unique movement of a unique physical artifact by the user.

In yet another aspect, a method for multifactor authentication utilizing augmented reality is provided. The method may include providing an augmented reality application for installation on a user device. The method may further include receiving authentication credentials from a user. The method may further include receiving, from the augmented reality application, a real-time visual feed of an environment of the user, where the environment contains one or more unique objects. The method may further include developing a three-dimensional rendering of the one or more unique objects and store the three-dimensional rendering of the one or more unique objects in a user data configuration.

In some embodiments, the method includes recognizing the one or more unique objects from the real-time visual feed of the environment of the user and compare the one or more unique objects within the real-time visual feed of the environment of the user to the three-dimensional rendering of the one or more unique objects and determine authenticity of the user. In some embodiments, where it is determined that there is a match between the one or more unique objects from the visual feed of the environment and the three-dimensional rendering of the one or more unique objects, the method includes granting access to the user. In some embodiments, where it is determined that there is not a match between the one or more unique objects from the visual feed of the environment and the three-dimensional rendering of the one or more unique objects, the method includes denying access to the user.

In some embodiments, the method includes prompting the user for authentication credentials; upon receiving correct authentication credentials, prompting the user for visual access to the one or more unique objects within the real-time visual feed of the environment of the user; and comparing the one or more unique objects from the real-time visual feed of the environment of the user to the three-dimensional rendering of the one or more unique objects. In some embodiments, where it is determined that there is a match between the one or more unique objects from the visual feed of the environment and the three-dimensional rendering of the one or more unique objects, the method includes granting access to the user. In some embodiments, where it is determined that there is not a match between the one or more unique objects from the visual feed of the environment and the three-dimensional rendering of the one or more unique objects, the method includes denying access to the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for multifactor authentication utilizing augmented reality, in accordance with an embodiment of the invention;

FIG. 2 illustrates technical components of an augmented reality system, in accordance with an embodiment of the invention;

FIG. 3 illustrates a process flow for the generation of augmented reality facilitated credentials, in accordance with an embodiment of the invention; and

FIG. 4 illustrates a process flow for augmented reality facilitated authentication in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some instances, a user may have a unique item, picture, object, gesture, or the like, that a system may associate with the user specifically. If the user is uniquely aware of the object's significance, the system may leverage a virtual connectivity to recognize the user's presence and further verify the user's identity by the user presenting the object to the virtual system for 3D analysis and recognition. In the event that the object is not present, the system may require additional verification steps since the user's surroundings may have changed. The system utilizes a unique approach for verifying users interacting with the system via an AR device or virtually augmented workspace or customer experience.

As used herein, an “entity” or “managing entity” may be any institution employing information technology resources and particularly technology infrastructure configured for processing large amounts of data. Typically, the data may be related to products, services, and/or the like offered and/or provided by the entity, customers of the entity, other aspect of the operations of the entity, people who work for the entity, and/or the like. As such, the entity may be an institution, group, association, financial institution, establishment, company, union, authority, merchant, service provider, and/or the like employing information technology resources for processing large amounts of data. In some embodiments, the entity may be an institution, group, association, financial institution, establishment, company, union, authority, merchant, service provider, and/or the like hosting, sponsoring, coordinating, creating, and/or the like events, recognitions, achievements, and/or the like.

As used herein, “entity system” or “managing entity system” may be the computing systems, devices, software, applications, communications hardware, and/or other resources used by the entity to perform the functions as described herein, or used to control or configure the described systems and its components. Accordingly, the entity system may comprise desktop computers, laptop computers, servers, Internet-of-Things (“IoT”) devices, networked terminals, mobile smartphones, auxiliary devices, smart devices (e.g., smart watches), network connections, and/or other types of computing systems or devices and/or peripherals along with their associated applications.

As used herein, a “user” may be an individual associated with an entity. As such, in some embodiments, the user may be an individual having past relationships, current relationships or potential future relationships with an entity. In some embodiments, a “user” may be an employee (e.g., an associate, a project manager, a manager, an administrator, an internal operations analyst, and/or the like) of the entity and/or enterprises affiliated with the entity, capable of operating systems described herein. In some embodiments, a “user” may be any individual, another entity, and/or a system who has a relationship with the entity, such as a customer, a prospective customer, and/or the like. In some embodiments, a user may be a system performing one or more tasks described herein. In some embodiments, a user may be a verified authority as described herein.

As used herein, a “user interface” may be any device or software that allows a user to input information, such as commands and/or data, into a device, and/or that allows the device to output information to the user. For example, a user interface may include an application programmer interface (API), a graphical user interface (GUI), and/or an interface to input computer-executable instructions that direct a processing device to carry out functions. The user interface may employ input and/or output devices to input data received from a user and/or output data to a user. Input devices and/or output devices may include a display, API, mouse, keyboard, button, touchpad, touch screen, microphone, speaker, LED, light, joystick, switch, buzzer, bell, and/or other devices for communicating with one or more users. In some embodiments, the user interface may be a combination of devices which interface to provide an augmented display experience. For instance, the user may wear an augmented reality (AR) or virtual reality (VR) headset, also referred to herein as the augmented reality (AR) system, which interfaces with one or more other displays or devices in order to provide an overlay of additional information. In some embodiments, the user interface may be tailored to a specific user's role, access permissions, preferences, or the like, as described herein. In some embodiments, the AR system may be one or more devices that operate to display a projection to one or more users. For instance, in some embodiments, as opposed to the user wearing a headset or other device, an augmented visual overlay of the user's surroundings may be presented using a holographic projection viewable to multiple users at once. In some embodiments, one or more AR systems, whether headset or projection-type systems, may operate in cooperation with a back-end augmented display system to receive device-specific or user-specific information. For instance, the augmented display system may transmit different perspective views to different areas, users, or the like, or may alter the perspective view of the visual overlay based on a known position of one or more users.

In some embodiments, the term “module” with respect to an apparatus may refer to a hardware component of the apparatus, a software component of the apparatus, and/or a component of the apparatus that includes both hardware and software. In some embodiments, the term “chip” may refer to an integrated circuit, a microprocessor, a system-on-a-chip, a microcontroller, and/or the like that may either be integrated into the external apparatus, may be inserted and/or removed from the external apparatus by a user, and/or the like.

As used herein, an “engine” may refer to core elements of a computer program, part of a computer program that serves as a foundation for a larger piece of software and drives the functionality of the software, and/or the like. An engine may be self-contained but may include externally controllable code that encapsulates powerful logic designed to perform or execute a specific type of function. In one aspect, an engine may be underlying source code that establishes file hierarchy, input and/or output methods, how a part of a computer program interacts and/or communicates with other software and/or hardware, and/or the like. The components of an engine may vary based on the needs of the computer program as part of the larger piece of software. In some embodiments, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system.

As used herein, a “component” of an application may include a software package, a service, a resource, a module, and/or the like that includes a set of related functions and/or data. In some embodiments, a component may provide a source capability (e.g., a function, a business function, and/or the like) to an application including the component. In some embodiments, components of an application may communicate with each other via interfaces and may provide information to each other indicative of the services and/or functions that other components may utilize and/or how other components may utilize the services and/or functions. Additionally, or alternatively, components of an application may be substitutable such that a component may replace another component. In some embodiments, components may include objects, collections of objects, and/or the like.

As used herein, “authentication credentials” may be any information that may be used to identify a user. For example, a system may prompt a user to enter authentication information such as a username, a password, a token, a personal identification number (PIN), a passcode, biometric information (e.g., voice authentication, a fingerprint, and/or a retina scan), an answer to a security question, a unique intrinsic user activity, such as making a predefined motion with a user device, and/or the like. The authentication information may be used to authenticate the identity of the user (e.g., determine that the authentication information is associated with an account) and/or determine that the user has authority to access an account or system. In some embodiments, the system may be owned and/or operated by an entity. In such embodiments, the entity may employ additional computer systems, such as authentication servers, to validate and certify resources inputted by a plurality of users within the system. The system may further use authentication servers to certify the identity of users of the system, such that other users may verify the identity of the certified users. In some embodiments, the entity may certify the identity of the users. Furthermore, authentication information and/or permission may be assigned to and/or required from a user, application, computing node, computing cluster, and/or the like to access stored data within at least a portion of the system.

As used herein, an “interaction” may refer to any communication between one or more users, one or more entities or institutions, and/or one or more devices, nodes, clusters, and/or systems within the system environment described herein. For example, an interaction may refer to a transfer of data between devices, an accessing of stored data by one or more nodes of a computing cluster, a transmission of a requested task, and/or the like. In some embodiments, an interaction may refer to an entity, a user, a system, and/or a device providing an advertisement, information, data, a user interface, and/or the like to another entity, another user, another system, and/or another device.

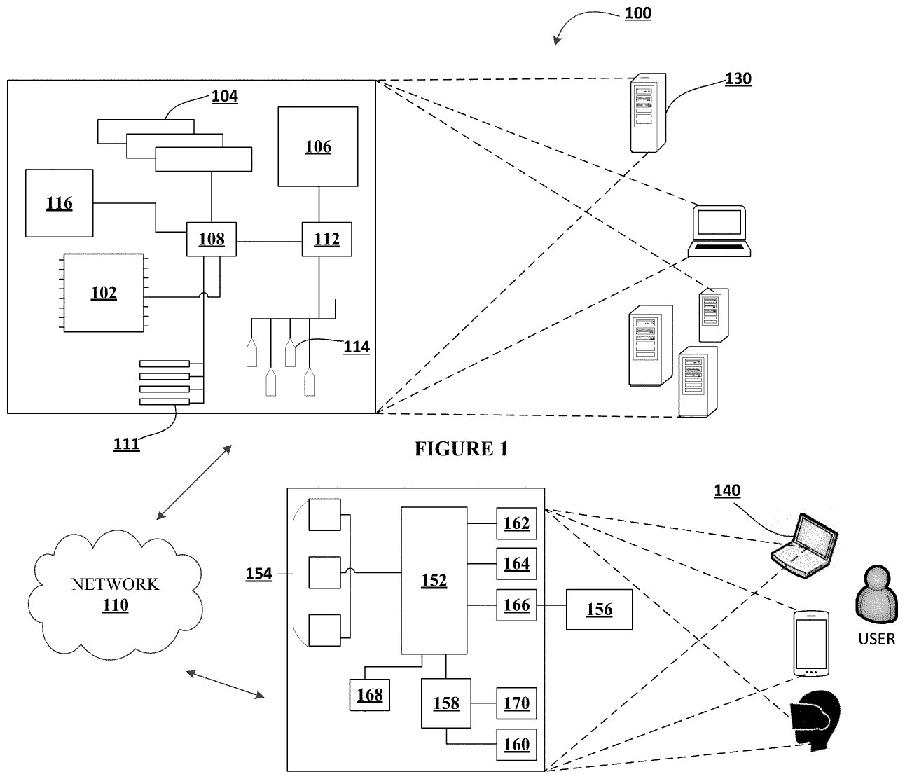

FIG. 1 presents an exemplary block diagram of a system environment 100 for multifactor authentication in accordance with an embodiment of the invention. FIG. 1 provides a system environment 100 that includes specialized servers and a system communicably linked across a distributive network of nodes required to perform functions of process flows described herein in accordance with embodiments of the present invention.

As illustrated, the system environment 100 includes a network 110, a system 130, and a user input system 140. The user input system 140 may be a mobile device, a non-mobile computing device, an augmented reality (AR) device, a virtual reality (VR) device, extended reality (XR) device, personal digital assistant, and/or the like. The user may be a person who uses the user input system 140 to access, view modify, interact with, and/or the like information, data, images, video, and/or the like. The user may be a person who uses the user input system 140 to initiate, perform, monitor, and/or the like changes and/or modifications to one or more systems, applications, services, and/or the like. The one or more systems, applications, services, and/or the like may be configured to communicate with the system 130, input information onto a user interface presented on the user input system 140, and/or the like. The applications stored on the user input system 140 and the system 130 may incorporate one or more parts of any process flow described herein.

As shown in FIG. 1, the system 130 and the user input system 140 are each operatively and selectively connected to the network 110, which may include one or more separate networks. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology.

In some embodiments, the system 130 and the user input system 140 may be used to implement processes described herein, including user-side and server-side processes generating limited-transferability electronic digital certificates associated with events, in accordance with an embodiment of the present invention. The system 130 may represent various forms of digital computers, such as laptops, desktops, workstations, personal digital assistants, servers, blade servers, mainframes, and/or the like. The user input system 140 may represent various forms of mobile devices, such as personal digital assistants, cellular telephones, smartphones, smart glasses, and/or the like. The components shown here, their connections, their relationships, and/or their functions, are meant to be exemplary only, and are not meant to limit implementations of the inventions described and/or claimed in this document.

In some embodiments, the system 130 may include a processor 102, memory 104, a storage device 106, a high-speed interface 108 connecting to memory 104, high-speed expansion ports 111, and a low-speed interface 112 connecting to low-speed bus 114 and storage device 106. Each of the components 102, 104, 106, 108, 111, and 112 may be interconnected using various buses, and may be mounted on a common motherboard or in other manners as appropriate. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130 may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The memory 104 may store information within the system 130. In one implementation, the memory 104 may be a volatile memory unit or units, such as volatile random-access memory (RAM) having a cache area for the temporary storage of information. In another implementation, the memory 104 may be a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 may be capable of providing mass storage for the system 130. In one aspect, the storage device 106 may be or contain a computer-readable medium, such as a floppy disk device, a hard disk device, an optical disk device, a tape device, a flash memory and/or other similar solid state memory device, and/or an array of devices, including devices in a storage area network or other configurations. A computer program product may be tangibly embodied in an information carrier. The computer program product may also contain instructions that, when executed, perform one or more methods, such as those described herein. The information carrier may be a non-transitory computer-readable or machine-readable storage medium, such as the memory 104, the storage device 106, and/or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 may manage bandwidth-intensive operations for the system 130, while the low-speed interface 112 and/or controller manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In some embodiments, low-speed interface 112 and/or controller is coupled to storage device 106 and low-speed bus 114 (e.g., expansion port). The low-speed bus 114, which may include various communication ports (e.g., USB, Bluetooth, Ethernet, wireless Ethernet), may be coupled to one or more input/output devices, such as a keyboard, a pointing device, a scanner, and/or a networking device such as a switch or router (e.g., through a network adapter).

The system 130 may be implemented in a number of different forms, as shown in FIG. 1. For example, it may be implemented as a standard server or multiple times in a group of such servers. Additionally, or alternatively, the system 130 may be implemented as part of a rack server system, a personal computer, such as a laptop computer, and/or the like. Alternatively, components from system 130 may be combined with one or more other same or similar systems and the user input system 140 may be made up of multiple computing devices communicating with each other.

FIG. 1 also illustrates a user input system 140, in accordance with an embodiment of the invention. The user input system 140 may include a processor 152, memory 154, an input/output device such as a display 156, a communication interface 158, and a transceiver 160, among other components, such as one or more image sensors. The user input system 140 may also be provided with a storage device, such as a microdrive and/or the like, to provide additional storage. Each of the components 152, 154, 158, and 160, may be interconnected using various buses, and several of the components may be mounted on a common motherboard or in other manners as appropriate.

The processor 152 may be configured to execute instructions within the user input system 140, including instructions stored in the memory 154. The processor 152 may be implemented as a chipset of chips that include separate and multiple analog and/or digital processors. The processor 152 may be configured to provide, for example, for coordination of the other components of the user input system 140, such as control of user interfaces, applications run by user input system 140, and/or wireless communication by user input system 140.

The processor 152 may be configured to communicate with the user through control interface 164 and display interface 166 coupled to a display 156. The display 156 may be, for example, a Thin-Film-Transistor Liquid Crystal Display (TFT LCD) or an Organic Light Emitting Diode (OLED) display, and/or other appropriate display technology. An interface of the display 156 may include appropriate circuitry and may be configured for driving the display 156 to present graphical and other information to a user. The control interface 164 may receive commands from a user and convert them for submission to the processor 152. In addition, an external interface 168 may be provided in communication with processor 152 to enable near area communication of user input system 140 with other devices. External interface 168 may provide, for example, for wired communication in some implementations, or for wireless communication in other implementations, and multiple interfaces may also be used.

The memory 154 may store information within the user input system 140. The memory 154 may be implemented as one or more of a computer-readable medium or media, a volatile memory unit or units, or a non-volatile memory unit or units. Expansion memory may also be provided and connected to user input system 140 through an expansion interface (not shown), which may include, for example, a Single In Line Memory Module (SIMM) card interface. Such expansion memory may provide extra storage space for user input system 140 and/or may store applications and/or other information therein. In some embodiments, expansion memory may include instructions to carry out or supplement the processes described above and/or may include secure information. For example, expansion memory may be provided as a security module for user input system 140 and may be programmed with instructions that permit secure use of user input system 140. Additionally, or alternatively, secure applications may be provided via the SIMM cards, along with additional information, such as placing identifying information on the SIMM card in a secure manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In some embodiments, a computer program product may be tangibly embodied in an information carrier. The computer program product may contain instructions that, when executed, perform one or more methods, such as those described herein. The information carrier may be a computer-readable or machine-readable medium, such as the memory 154, expansion memory, memory on processor 152, and/or a propagated signal that may be received, for example, over transceiver 160 and/or external interface 168.

In some embodiments, the user may use the user input system 140 to transmit and/or receive information and/or commands to and/or from the system 130. In this regard, the system 130 may be configured to establish a communication link with the user input system 140, whereby the communication link establishes a data channel (wired and/or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, and/or the like.

The user input system 140 may communicate with the system 130 (and one or more other devices) wirelessly through communication interface 158, which may include digital signal processing circuitry. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker (e.g., in a handset) of user input system 140. Such sound may include sound from voice telephone calls, may include recorded sound (e.g., voice messages, music files, and/or the like) and may also include sound generated by one or more applications operating on the user input system 140, and in some embodiments, one or more applications operating on the system 130.

Various implementations of the systems and techniques described here may be realized in digital electronic circuitry, integrated circuitry, specially designed ASICs (application specific integrated circuits), computer hardware, firmware, software, and/or combinations thereof. Such various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and/or at least one output device.

Computer programs (e.g., also referred to as programs, software, applications, code, and/or the like) may include machine instructions for a programmable processor, and may be implemented in a high-level procedural and/or object-oriented programming language, and/or in assembly/machine language. As used herein, the terms “machine-readable medium” and/or “computer-readable medium” may refer to any computer program product, apparatus and/or device (e.g., magnetic discs, optical disks, memory, Programmable Logic Devices (PLDs), and/or the like) used to provide machine instructions and/or data to a programmable processor, including a machine-readable medium that receives machine instructions as a machine-readable signal. The term “machine-readable signal” may refer to any signal used to provide machine instructions and/or data to a programmable processor.

To provide for interaction with a user, the systems and/or techniques described herein may be implemented on a computer having a display device (e.g., a CRT (cathode ray tube), an LCD (liquid crystal display) monitor, and/or the like) for displaying information to the user, a keyboard by which the user may provide input to the computer, and/or a pointing device (e.g., a mouse or a trackball) by which the user may provide input to the computer. Other kinds of devices may be used to provide for interaction with a user as well. For example, feedback provided to the user may be any form of sensory feedback (e.g., visual feedback, auditory feedback, and/or tactile feedback). Additionally, or alternatively, input from the user may be received in any form, including acoustic, speech, and/or tactile input.

The systems and techniques described herein may be implemented in a computing system that includes a back end component (e.g., as a data server), that includes a middleware component (e.g., an application server), that includes a front end component (e.g., a client computer having a graphical user interface or a Web browser through which a user may interact with an implementation of the systems and techniques described here), and/or any combination of such back end, middleware, and/or front end components. Components of the system may be interconnected by any form or medium of digital data communication (e.g., a communication network). Examples of communication networks include a local area network (“LAN”), a wide area network (“WAN”), and/or the Internet.

In some embodiments, computing systems may include clients and servers. A client and server may generally be remote from each other and typically interact through a communication network. The relationship of client and server may arise by virtue of computer programs running on the respective computers and having a client-server relationship to each other.

The embodiment of the system environment 100 illustrated in FIG. 1 is exemplary and other embodiments may vary. As another example, in some embodiments, the system 130 includes more, less, or different components. As another example, in some embodiments, some or all of the portions of the system environment 100, the system 130, and/or the user input system 140 may be combined into a single portion. Likewise, in some embodiments, some or all of the portions of the system environment 100, the system 130, and/or the user input system 140 may be separated into two or more distinct portions.

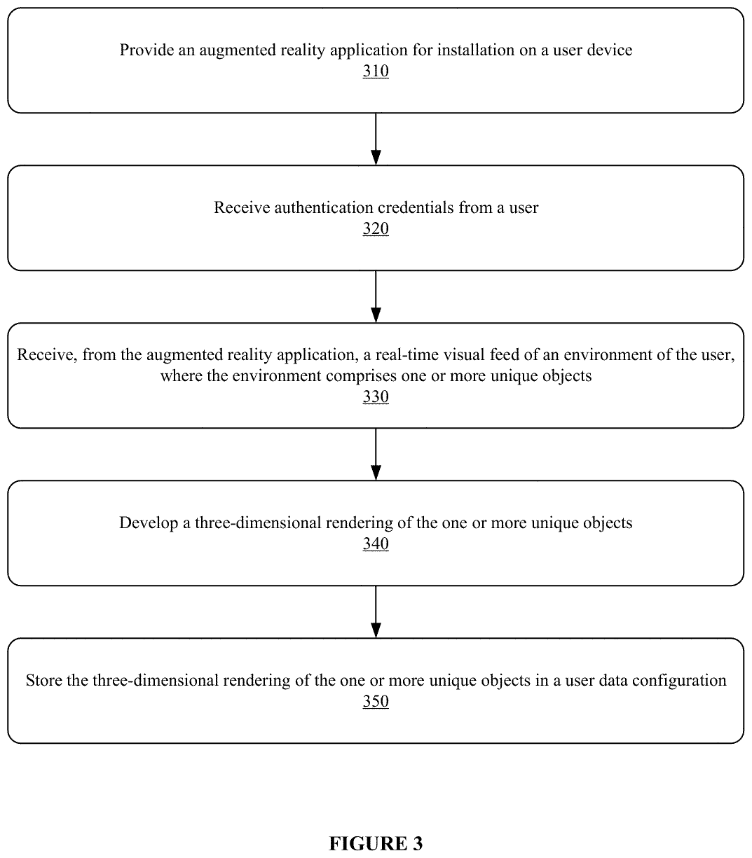

In some embodiments, the system environment 100 may include one or more user input systems and/or one or more multifactor authentication systems (e.g., similar to the system 130 and/or the user input system 140) associated with an entity (e.g., a business, a merchant, a financial institution, a card management institution, an software and/or hardware development company, a software and/or hardware testing company, and/or the like). For example, a user (e.g., an employee, a customer, and/or the like) may use a user input system (e.g., similar to the user input system 140) to initiate multifactor authentication (e.g., similar to the system 130, running a system similar to the system 130, and/or the like) and the user input system may provide information (e.g., event information, user information, and/or the like) to a multifactor authentication system (e.g., similar to the system 130, running a system similar to the system 130, and/or the like). In some embodiments, the user input system and/or the multifactor authentication system associated with the entity may perform one or more of the steps described herein with respect to the process flows described herein with respect to FIGS. 3, and/or 4.

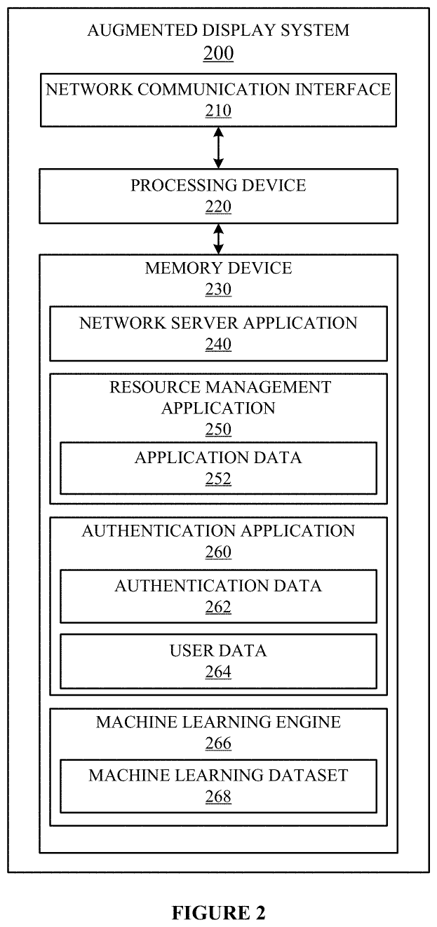

FIG. 2 provides a block diagram illustrating the augmented display system 200, in greater detail, in accordance with embodiments of the invention. As illustrated in FIG. 2, in one embodiment of the invention, the augmented display system 200 includes one or more processing devices 220 operatively coupled to a network communication interface 210 and a memory device 230. In certain embodiments, the augmented display system 200 is operated by a first entity, such as a financial institution, while in other embodiments, the augmented display system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the augmented display system 200 described herein. For example, in one embodiment of the augmented display system 200, the memory device 230 includes, but is not limited to, a network server application 240, a resource management application 250 which includes application data 252, an authentication application 260 which includes a authentication data 262 and user data 254, and other computer-executable instructions or other data. The computer-executable program code of the network server application 240, the resource management application 250, and/or the authentication application 260 may instruct the processing device 220 to perform certain logic, data-processing, and data-storing functions of the augmented display system 200 described herein, as well as communication functions of the augmented display system 200.

In one embodiment, the resource management application 250 includes application data 252. The application data 252 may comprise information for storing data or information associated with one or more users, their preferences, or their current application session. The application data 252 may additionally or alternatively include information for comparing data received from third party systems, managing entity system 130, or the like, such as account information, web services information, application usage information, login session information, user preferences, user role within an entity, or the like, to a stored database (e.g., a relational database) of associated information. In another embodiment, the application data 252 may include resource information, for instance, when the augmented display system 300 receives information from the managing entity system 200, the resource management application 250 can parse the data and display it via one or more user device(s) 140, or partially display certain information via one or more AR system(s), based on the user's preferences or permissions (e.g., the augmented display system 200 may route sensitive data to the AR system in order to reduce the ability for unauthorized viewing, or the like).

In one embodiment, the authentication application 260 includes authentication data 262 and user data 264. The authentication data 262 may include passwords, personal identification numbers, security questions, unique biometric information, dynamic two-factor authentication information, system security status, authentication images (e.g., security footage, or the like), stepped-up authentication information (e.g., tiered security information allowing users to access some data, but wherein they must provide additional authentication or verification information to access other, more sensitive information), or other authentication credentials (including secondary or stepped-up authentication credentials) associated with one or more users. This authentication data 262 can be accessed by the authentication application 260 to compare received authentication credentials to the stored authentication credentials when determining whether a user is authorized for viewing certain information, or for determining which information is displayed via one or more AR system(s) automatically as an augmented overlay. For example, all users may see a baseline augmentation of the managing entity system 130 portal or interface, but only certain users who provide stepped-up authorization credentials via the AR systems or user device 140 may receive a fully augmented view of certain information, such as user account information, system resources, system architecture or status, or the like. The user data 264 may comprise any additional information that the authentication application 260 may store for use in authenticating a user (e.g., establishing a contactless NFC chip for a user to authenticate via their user device 140, or the like).

The network server application 240, the resource management application 250, and the authentication application 260 are configured to invoke or use the application data 252, the authentication data 262, and the user data 264, when communicating through the network communication interface 210 with the managing entity system 200, the one or more user device(s) 140, the AR system, and/or third party systems 140.

The augmented display system 200 may also contain a machine learning engine 266 and machine learning dataset(s) 268. The machine learning engine 266 may store instructions and/or data that may cause or enable the augmented display system 200 to receive, store, and/or analyze data received by the managing entity system 130, user's device 140, or AR system 120. The machine learning engine 266 and machine learning dataset 268 may store instructions and/or data that cause or enable the augmented display system 200 to determine patterns and correlations within received user data. In some embodiments, the machine learning dataset(s) 268 may contain data relating to user activity or device information, which may be stored in a user account managed by the managing entity system 130.

The machine learning engine 266 may receive data from a plurality of sources and, using one or more machine learning algorithms, may generate one or more output statistics stored in the machine learning dataset(s) 268. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. It is understood that additional or alternative machine learning algorithms may be used without departing from the invention. Data generated by the machine learning engine 266 may be utilized by the augmented display system 200 in order to inform recommendations for one or more users. For instance, machine learning engine 266 may identify that a certain percentage of users experienced increased productivity (as determined by interaction time with one or more applications associated with productivity) when implementing a certain augmented reality aspect via AR system, and may recommend those certain aspects to other similar users.

FIG. 3 illustrates a process flow 300 for the generation of augmented reality facilitated credentials, in accordance with an embodiment of the invention. In some embodiments, the augmented reality credential generating system and/or the like (e.g. similar to one or more of the systems described herein with respect to FIGS. 1 and/or 2) may perform one or more of the steps of process flow 300.

As shown in block 310, the process flow 300 may include providing an augmented reality application for installation on a user device. For example, the system may provide an augmented reality application to an AR device, a mobile device, and/or the like

As shown in block 320, the process flow 300 may include receiving authentication credentials from a user.

As shown in block 330, the process flow 300 may include receiving, from the augmented reality application, a real-time visual feed of an environment of the user. in some embodiments, the environment of the user contains one or more unique objects. In some embodiments, the one or more unique objects may be a physical artifact. For example, a unique physical artifact that the user recognizes as unique to them. Examples include: a picture, a desk ornament, jewelry, etc. In some embodiments, the one or more unique objects may be a gesture of the user. For example, the user may perform a gesture that they have determined to be unique to them. Examples include: blinking, nodding, pointing, hand gestures, etc. In some embodiments, the one or more unique objects may be the movement of a physical artifact by the user. For example, the user may move the unique physical artifact in a unique manner. Examples include: rotating the unique object, pointing to the unique object, moving the unique object in a unique manner, etc.

Process flow 300 may include additional embodiments, such as any single embodiment or any combination of embodiments described below and/or in connection with one or more other processes described elsewhere herein.

In a first embodiment, the process flow 300 may include recognizing the one or more unique objects from the real-time visual feed of the environment of the user.

In a second embodiment, alone or in combination with the first embodiment, the process flow 300 may include comparing the one or more unique objects from the real-time visual feed of the environment of the user to the three-dimensional rendering of the one or more unique objects.

In a third embodiment, alone or in combination with any one of the first or second embodiments, the process flow 300 may include determining the authenticity of the user.

In a fourth embodiment, alone or in combination with any one of the first through third embodiments, the process flow 300 may include granting access to the user.

In a fifth embodiment, alone or in combination with any one of the first through fourth embodiments, the process flow 300 may include denying access to the user.

In a sixth embodiment, alone or in combination with any one of the first through fifth embodiments, the process flow 300 may include prompting the user for authentication credentials.

In a seventh embodiment, alone or in combination with any one of the first through sixth embodiments, the process flow 300 may include, upon receiving authentication credentials, prompting the user for visual access to the one or more unique objects from the real-time visual feed of the environment of the user.

In an eighth embodiment, alone or in combination with any one of the first through seventh embodiments, the process flow 300 may include comparing the one or more unique objects from the real-time visual feed of the environment of the user to the three-dimensional rendering of the one or more unique objects.

Although FIG. 3 shows example blocks of process flow 300, in some embodiments, process flow 300 may include additional blocks, fewer blocks, different blocks, or differently arranged blocks than those depicted in FIG. 3. Additionally, or alternatively, two or more of the blocks of process flow 300 may be performed in parallel.

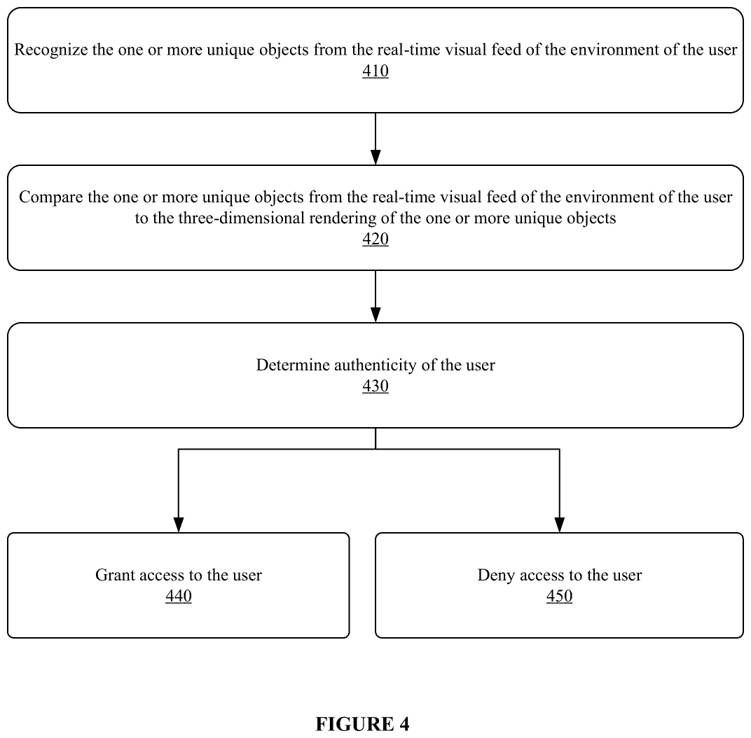

FIG. 4 illustrates a process flow 400 for the generation of augmented reality facilitated credentials, in accordance with an embodiment of the invention. In some embodiments, the augmented reality credential generating system and/or the like (e.g. similar to one or more of the systems described herein with respect to FIGS. 1 and/or 2) may perform one or more of the steps of process flow 400.

As shown in block 410, the process flow 400 may include recognizing the one or more unique objects from the real-time visual feed of the environment of the user.

As shown in block 420 the process flow 400 may include comparing the one or more unique objects from the real-time visual feed of the environment of the user to the three-dimensional rendering of the one or more unique objects.

As shown in block 430, the process flow 400 may include determining the authenticity of the user, where determining the authenticity of the user is based on the comparison of the one or more unique objects from the real-time visual feed of the environment of the user to the three-dimensional rendering of the one or more unique objects. If after comparing the one or more unique objects from the real time visual feed of the environment to the three-dimensional rendering, there is no match, then following determining the authenticity of the user, the process flow 400 may include granting access to the user as shown in block 440. Alternatively, after comparing the one or more unique objects from the real time visual feed of the environment to the three-dimensional rendering, there is no match, then after determining the authenticity of the user, the process flow 400 may include denying access to the user as shown in block 450.

Although FIG. 4 shows example blocks of process flow 400, in some embodiments, process flow 400 may include additional blocks, fewer blocks, different blocks, or differently arranged blocks than those depicted in FIG. 4. Additionally, or alternatively, two or more of the blocks of process flow 400 may be performed in parallel.

In some embodiments, the one or more unique objects is a unique physical object. In this embodiment, the unique physical artifact is an object of the user where the user knows the physical artifact is unique. Additionally, or alternatively, the one or more unique objects may be a gesture by the user. As an example, the user may nod, wink, blink, wave, point, or perform any other gesture. In some embodiments, the one or more unique objects is a unique movement of a unique physical artifact by the user. As an example, the user may point to the unique physical artifact, shake a unique physical artifact, turn a unique physical artifact, place the unique physical artifact in a specific location, or any other movement of the unique physical artifact. In some embodiments, the one or more unique objects is a virtual object within the augmented reality of the user. Additionally, or alternatively, the one or more unique objects is a manipulation of a virtual object within the augmented reality of the user by the user.

In some embodiments, the three-dimensional rendering of the one or more unique objects may be developed based on determining positional parameters of the one or more unique objects. The positional parameters may be determined in a number of different ways. As an example, the positional parameters may be determined using various ranging technologies that employ light, sound, electromagnetic signals, and/or the like to measure time-of-flight of these signals to collect measurements of the real-time visual feed and the objects contained therewithin. In another example, the system may be configured to determine that the one or more unique objects are associated with one or more radio frequency identification (RFID) tags. RFID technology uses electromagnetic fields to automatically identify and track tags associated with objects. In response, the system may be configured to receive one or more codes from the one or more RFID tags associated with the one or more unique objects. In response the system may be configured to develop the three-dimensional rendering based on the one or more positional parameters associated with the one or more unique objects based on at least the one or more codes.

In some embodiments, the three-dimensional rendering of the one or more unique objects may be developed based on determining a three-dimensional structure of the one or more unique objects. The three-dimensional structure may be determined in a number of ways. As an example, the positional parameters may be determined using various ranging technologies that employ light, sound, electromagnetic signals, and/or the like to measure time-of-flight of these signals to collect measurements of the real-time visual feed and the objects contained therewithin. Additionally, or alternatively, the three-dimensional structure of the one or more objects may be determined using a photometric stereo imaging technique. Photometric stereo imaging techniques use multiple two-dimensional images from a fixed camera perspective with different illumination directions to develop a three-dimensional reconstruction of an object. Any other three-dimensional imaging technique known in the art may be used to develop a three-dimensional rendering of the one or more objects.

In some embodiments, the system may transmit control signals configured to cause the user device to display to the user a notification indicating that the user has been granted access. Additionally, or alternatively, the system may transmit control signals configured to cause the user device to display to the user a notification indicating that the user has been denied access. In some embodiments, when the user is denied access the system may prompt the user for an alternative method of authentication.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that may direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the invention. Therefore, it is to be understood that, within the scope of the appended claims, the invention may be practiced other than as specifically described herein.

What is claimed is:

1. A system for multifactor authentication, the system comprising
at least one non-transitory storage device, and
at least one processing device coupled to the at least one non-transitory storage device, wherein the at least one processing device is configured to:
provide an augmented reality application for installation on a user device;
receive authentication credentials from a user;
receive, from the augmented reality application, a real-time visual feed of an environment of the user, wherein the environment comprises one or more unique objects;
develop a three-dimensional rendering of the one or more unique objects; and
store the three-dimensional rendering of the one or more unique objects in a user data configuration.

2. The system according to claim 1, wherein the at least one processing device is further configured to:
recognize the one or more unique objects from the real-time visual feed of the environment of the user,
compare the one or more unique objects from the real-time visual feed of the environment of the user to the three-dimensional rendering of the one or more unique objects, and
determine authenticity of the user.

3. The system according to claim 1, wherein the at least one processing device is further configured to:
prompt the user for authentication credentials;
upon receiving correct authentication credentials, prompt the user for visual access to the one or more unique objects within the real-time visual of the environment of the user;
compare the one or more unique objects from the real-time visual feed of the environment of the user to the three-dimensional rendering of the one or more unique objects; and
determine authenticity of the user.

4. The system according to claim 1, wherein the one or more unique objects is a unique physical artifact.

5. The system according to claim 1, wherein the one or more unique objects is a unique gesture of the user.

6. The system according to claim 1, wherein the one or more unique objects is a unique movement of a unique physical artifact by the user.

7. A computer program product for multifactor authentication, the computer program product comprising a non-transitory computer-readable medium comprising code causing a first apparatus to:
provide an augmented reality application for installation on a user device;
receive authentication credentials from a user;
receive, from the augmented reality application, a real-time visual feed of an environment of the user, wherein the environment comprises one or more unique objects;
develop a three-dimensional rendering of the one or more unique objects; and
store the three-dimensional rendering of the one or more unique objects in a user data configuration.

8. The computer program product according to claim 7, wherein the non-transitory computer-readable medium comprises code causing the first apparatus to:
recognize the one or more unique objects from the real-time visual feed of the environment of the user,
compare the one or more unique objects from the real-time visual feed of the environment of the user to the three-dimensional rendering of the one or more unique objects, and
determine authenticity of the user.

9. The computer program product according to claim 7, wherein the non-transitory computer-readable medium comprises code causing the first apparatus to:
prompt the user for authentication credentials;
upon receiving correct authentication credentials, prompt the user for visual access to the one or more unique objects within the real-time visual of the environment of the user;
compare the one or more unique objects from the real-time visual feed of the environment of the user to the three-dimensional rendering of the one or more unique objects; and
determine authenticity of the user.

10. The computer program product according to claim 7, wherein the one or more unique objects is a unique physical artifact.

11. The computer program product according to claim 7, wherein the one or more unique objects is a unique gesture of the user.

12. The computer program product according to claim 7, wherein the one or more unique objects is a unique movement of a unique physical artifact by the user.

13. A method for multifactor authentication, the method comprising:
providing an augmented reality application for installation on a user device;
receiving authentication credentials from a user;
receiving, from the augmented reality application, a real-time visual feed of an environment of the user, wherein the environment comprises one or more unique objects;
developing a three-dimensional rendering of the one or more unique objects; and
storing the three-dimensional rendering of the one or more unique objects in a user data configuration.

14. The method according to claim 13, further comprising:
recognizing the one or more unique objects from the real-time visual feed of the environment of the user, and
comparing the one or more unique objects from the real-time visual feed of the environment of the user to the three-dimensional rendering of the one or more unique objects.

15. The method of claim 14, wherein the method further comprises:
determining that there is a match between the one or more unique objects from the real-time visual feed of the environment and the three-dimensional rendering of the one or more unique objects, and
granting access to the user.

16. The method of claim 14, wherein the method further comprises:
determining that there is not a match between the one or more unique objects from the real-time visual feed of the environment and the three-dimensional rendering of the one or more unique objects, and
denying access to the user.

17. The method of claim 13, further comprising:
prompting the user for authentication credentials;
upon receiving correct authentication credentials, prompting the user for visual access to the one or more unique objects within the real-time visual of the environment of the user; and
comparing the one or more unique objects from the real-time visual feed of the environment of the user to the three-dimensional rendering of the one or more unique objects.

18. The method of claim 17, wherein the method further comprises:
determining that there is a match between the one or more unique objects from the real-time visual feed of the environment and the three-dimensional rendering of the one or more unique objects, and
granting access to the user.

19. The method of claim 17, wherein the method further comprises:
determining that there is not a match between the one or more unique objects from the real-time visual feed of the environment and the three-dimensional rendering of the one or more unique objects, and
denying access to the user.

20. The method of claim 13, wherein the one or more unique objects is selected from the group consisting of a unique physical artifact, a unique gesture of the user, and a unique movement of a unique physical artifact by the user.
